(19) United States
(12) Patent Application Publication
(10) Pub. No.: US 2007/0040661 A1
(43) Pub. Date: Feb. 22, 2007

(54) In-vehicle display device and vehicle surroundings monitor

(75) Inventors: Mitsuo Takemura, Mie (JP); Kenichi Mori, Mie (JP); Akio Ishihara, Mie (JP)

Correspondence Address: OLIFF & BERRIDGE, PLC, P.O. BOX 19928, ALEXANDRIA, VA, 22320, US

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka-shi (JP)

(21) Appl. No.: 10/579,043

(22) PCT Filed: Nov. 11, 2004
(86) PCT No.: PCT/JP04/16751

§ 371 Date: May 10, 2006

(30) Foreign Application Priority Data
Nov. 14, 2003 (JP) 2003-384955

(51) Int. Cl. G09F 9/00

(52) U.S. Cl. 340/461

(57) ABSTRACT

The present invention provides an in-vehicle display device in which a captured image of the surroundings of the vehicle can be suppressed in strain due to anisotropic enlargement processed lengthwise and breadthwise and the display unit can be efficiently used to display. Then, in the in-vehicle display device, a matrix display type liquid crystal display panel unit is provided on a display device body. The liquid crystal display panel unit uses a substantially square display unit in which a plurality of pixels are provided in matrix shape. Specifically, as for shape of the display unit, longitudinal size is set to enter within a range from 0.95 to 1.2 when the lateral size is 1 and, more specifically, the longitudinal size is set to be approximately 1.1 when the lateral size is 1.

### TECHNICAL FIELD

The present invention relates to an in-vehicle display device capable of displaying images of the surroundings of a vehicle, captured by an in-vehicle camera and a vehicle surroundings monitor using the same.

### BACKGROUND ART

FIG. 13 is a view typically showing a state where the surroundings of a vehicle are captured by a vehicle surroundings monitor according to background art of the present invention. The vehicle surroundings monitor, as shown in FIG. 13, captures a region (for example, a lateral region A1 on the side of a front passenger seat) opposed to the vehicle side in the surroundings of the vehicle by an in-vehicle camera 33 mounted on a side portion (for example, a side mirror) of the front passenger seat side (for example, a left side) of the vehicle. Then, its captured image Ia1 is displayed by a display device (in-vehicle display device) mounted in the vehicle interior and the vehicle surroundings are monitored on the basis of the display image. The captured image Ia1 shown in FIG. 13 is one in which the lateral region A1 is captured when the vehicle is parking in a parking space of a parking area. In FIG. 13, reference numeral 101 denotes an image of an other vehicle and reference numeral 103 denotes an image in which the side portion of the front passenger seat side of the own vehicle is come out.

Here, since a popularized product is used as the in-vehicle camera 33, a product in which a ratio between lateral size ST1 and longitudinal size SL1 of the captured image Ia1 is set to 4 to 3 has been generally used. Furthermore, the in-vehicle camera 33 is set so that the captured image Ia1 is to be transversely long because the lateral region A1 needs to be imaged in a range which is wider in the anteroposterior direction along its direction of motion than the transversely direction at the front passenger seat side of the vehicle.

FIG. 14 is a view of configuration of a display unit 111a of a display panel unit 111 provided on a conventional display device. The display panel unit 111 is provided with a plurality of pixels in matrix shape, for performing image display on the display unit 111a and the display unit 111a performs display of the captured image Ia or the like. Furthermore, in the display panel unit 111, configuration seen from the front of the display unit 111a is set so that a ratio between lateral size ST11 (for example, 145 mm) and longitudinal size SL12 (for example, 80 mm) is to be 16 to 9.

Then, if the captured image Ia1 of the in-vehicle camera 33 is displayed by such the display panel unit 111, an aspect as shown in FIG. 14 appears. In this aspect shown in FIG. 14, the captured image Ia1 is displayed in a state where the captured image Ia1 is rotated anticlockwise by 90 degrees within a plane parallel to the page space so that the longitudinal direction of the captured image Ia1 corresponds to a direction of motion of the vehicle while taking into account of visibility when a driver watches the displayed captured image Ia1. Furthermore, in the aspect shown in FIG. 14, the captured image Ia1 is displayed in a state where the captured image Ia1 is left-aligned on the extreme left side of the display unit 111a. In addition, as for other display aspects, it may be considerable that the captured image Ia1 rotated by 90 is displayed by laterally enlarging so as to correspond to the lateral size ST11 of the display unit 111a, as shown in FIG. 15.

However, the display device provided with the conventional display panel unit 111 shown in FIG. 14 and FIG. 15 has the following problems. That is, in the case where the display aspect shown in FIG. 14 is adopted, an area of a use region 111b to an area of the display unit 111a is small (a usage rate of 40 percent) and there generates a large non-use region 111c on the right side of the display unit 111a, resulting in a problem that usage efficiency of the display unit 111a is bad. In the case where the display aspect shown in FIG. 15 is adopted, although the whole face of the display unit 111a is used, there is a problem in that the image Ia1 is laterally anisotropically largely enlarged and thereby generating a large strain in the image Ia1.

### DISCLOSURE OF THE INVENTION

The present invention has been made to solve the problem described above, and an object of the present invention is to provide an in-vehicle display device and a vehicle surroundings monitor using the same, which suppresses strain due to anisotropic enlargement processed lengthwise and breadthwise on a captured image of the surroundings of a vehicle and can efficiently use a display unit to display.

According to a first aspect of the present invention, there is provided an in-vehicle display device mounted on a front panel in the vehicle interior of a vehicle, the in-vehicle display device including: a dot matrix type display panel unit provided with a display unit which performs image display of the display panel unit and is set to be substantially square seen from the front.

Furthermore, according to a second aspect of the present invention, in the first aspect, the display unit of the display panel unit is set so that longitudinal size enters within a range of 0.95 to 1.2 when lateral size is 1.

Further, according to a third aspect of the present invention, in the second aspect, the display unit of the display panel unit is set so that longitudinal size is set to be approximately 1.1 when lateral size is 1.

Still, according to a fourth aspect of the present invention, in any of the first aspect to the third aspect, further including: a control unit which switches at least any one piece of information of information on air conditioner operation, information for vehicle control, and clock information and displays on the display panel unit, and the control unit switchably includes a first mode which switches at least any one piece of the information and displays on the display panel unit; and a second mode which displays, on the basis of an image signal which make input from an in-vehicle camera for imaging the surroundings of the vehicle, an image corresponding to the image signal on the display device body.

Furthermore, according to a fifth aspect of the present invention, there is provided a vehicle surroundings monitor for displaying an captured image of the surroundings of a vehicle in the vehicle interior, the vehicle surroundings monitor including: an in-vehicle camera which images the surroundings of the vehicle; and an in-vehicle display device as set forth in any one of the first aspect to the fourth aspect, which is mounted in the vehicle interior and displays an image imaged by the in-vehicle camera.

Further, according to a sixth aspect of the present invention, in the fifth aspect, the in-vehicle camera images a region opposed to the vehicle side in the surroundings of the vehicle.

Still, according to a seventh aspect of the present invention, in the fifth aspect, the in-vehicle camera images a region of the vehicle backward in the surroundings of the vehicle.

Then, according to the first to the seventh aspects, the display panel unit having the display unit of the substantially square seen from the front is used. Therefore it is possible to suppress strain due to anisotropic enlargement processed lengthwise and breadthwise on the images of the surroundings of the vehicle imaged by the in-vehicle camera (particularly, a lateral region of the front passenger seat side or a backward region of the vehicle) and also to efficiently use the display unit to display in large display size. In addition, display panel unit can also be reduced in size.

According to the fourth aspect, an indicator provided for displaying operation information or the like of an air conditioner is replaced with the dot matrix display type display device, whereby it is possible that in addition to the display of a captured image of the camera, a display for operating the air conditioner, which has not been able to be displayed by other than fixed patterns in the past, can be developed to be highly precise and also be responsive to the display contents of various kinds of information.

Furthermore, it is not necessary to provide an exclusive display device for performing the camera display and an installation space for the display device.

Further, the control unit provided with the in-vehicle display device according to the present invention switchably includes the first mode for displaying the operation information or the like of the air conditioner on the display device body and the second mode for displaying the captured image of the in-vehicle camera on the display device body. Therefore, the vehicle surroundings monitor can be introduced by only adding the in-vehicle camera or the like, without changing configuration of the control unit.

According to the sixth aspect, the substantially square display unit is suitable for displaying the captured image of the region opposed to the vehicle side in the surroundings of the vehicle and the captured image of the region opposed to the vehicle side can be efficiently displayed using the substantially square display unit.

According to the seventh aspect, the substantially square display unit is suitable for displaying the captured image of the region of the vehicle backward in the surroundings of the vehicle and the captured image of the region of the vehicle backward can be efficiently displayed using the substantially square display unit.

Objects, features, aspects, and advantages of the present invention will be more apparent from the following detail description and the accompanying drawings.

### BRIEF DESCRIPTION OF THE DRAWINGS

FIG. 1 is a block diagram of an in-vehicle display device according to one embodiment of the present invention;

FIG. 2 is a view showing an installation form of a display device body or the like in the in-vehicle display device of FIG. 1;

FIG. 3 is a plan view showing configuration of a display unit of a liquid crystal display panel unit;

FIG. 4 is a plan view showing configuration of the display unit of the liquid crystal display panel unit;

FIG. 5 is a view showing an enlarged relevant part of FIG. 2;

FIG. 6 is a view showing an information display screen;

FIG. 7 is a view showing an information display screen;

FIG. 8 is a view showing an information display screen;

FIG. 9 is a view showing an information display screen;

FIG. 10 is a view showing an information display screen;

FIG. 11 is a view showing an information display screen;

FIG. 12 is a view showing a modification example of an installation form of an in-vehicle camera;

FIG. 13 is a view typically showing a state where the surroundings of a vehicle are imaged by a vehicle surroundings monitor according to background art of the present invention;

FIG. 14 is a view showing configuration of a display unit of a display panel unit provided in a conventional display device; and

FIG. 15 is a view showing configuration of the display unit of the display panel unit provided in the conventional display device.

### BEST MODE FOR CARRYING OUT THE INVENTION

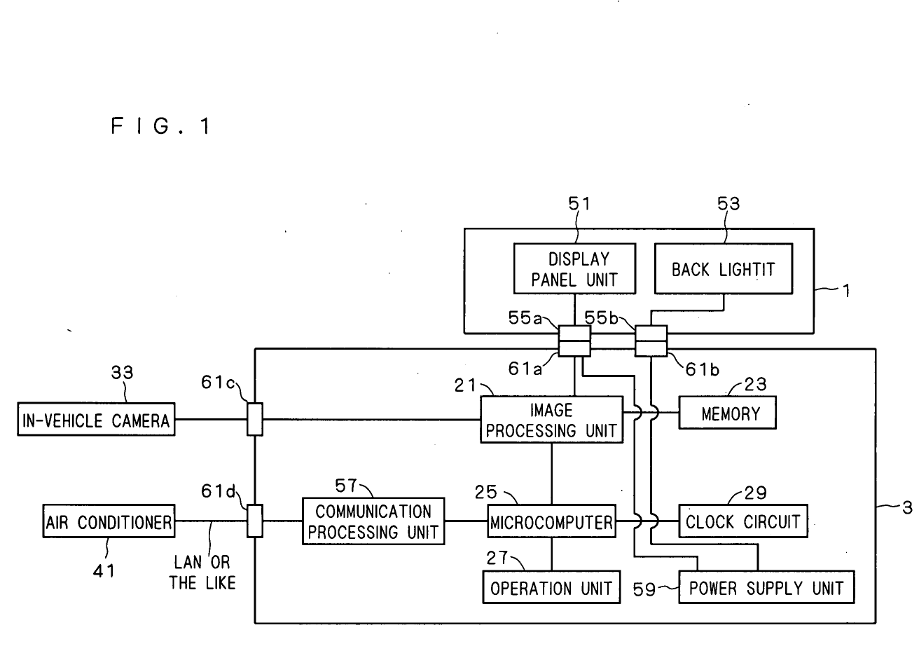

FIG. 1 is a block diagram of an in-vehicle display device according to one embodiment of the present invention. The in-vehicle display device, as shown in FIG. 1, is constituted by a dot matrix display type display device body 1 and a control unit 3, and constitutes a vehicle surroundings monitor by accompanying an in-vehicle camera 33 to be described later.

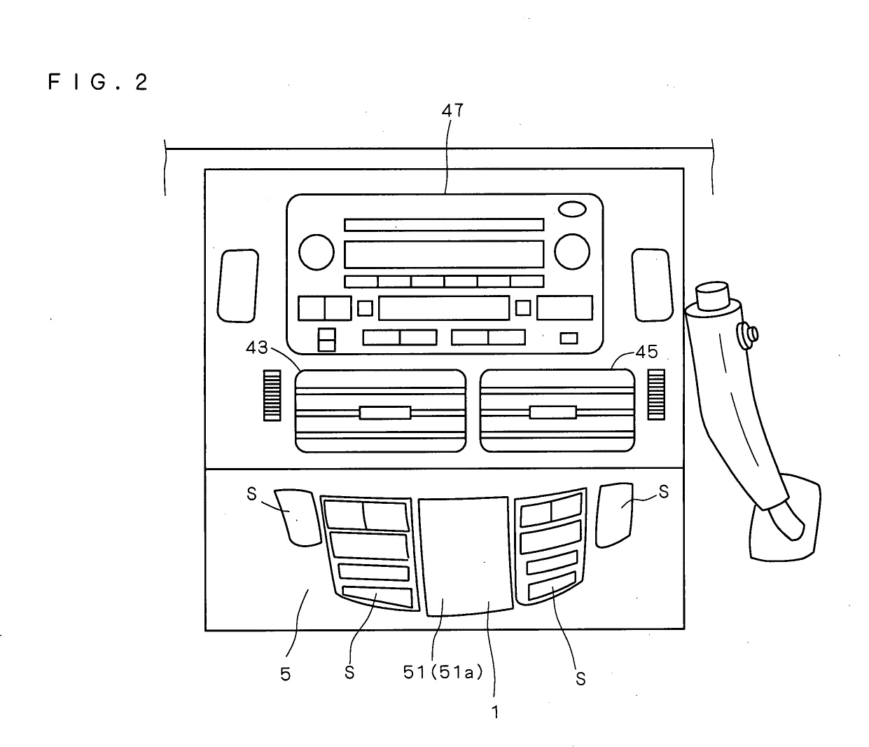

The display device body 1 is constituted by an organic electro luminescence display or a liquid crystal display such as a TFT type, and mounted by being embedded in a heater control panel unit 5 mounted at a substantially center portion of the right-and-left direction of a front panel in the vehicle interior of a vehicle, as shown in FIG. 2. In a configuration example shown in FIG. 2, a plurality of operation switches S for operating the in-vehicle display device, an air conditioner 41, and the like are provided on either side of the display device body 1. Furthermore, blowing out openings 43 and 45 of the air conditioner 41 are provided above the display device body 1 and an audio appliance 47 is further provided thereabove.

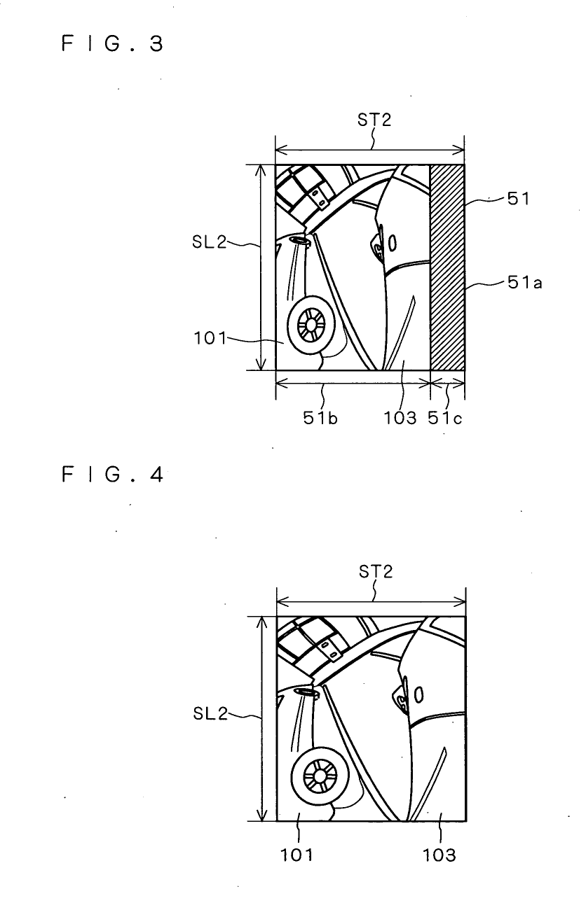

Further, in this embodiment, the display device body 1 is constituted by a TFT type liquid crystal display panel unit 51 and a backlight 53. A display unit 51a provided with a plurality of pixels in matrix shape for displaying image of the liquid crystal display panel unit 51 is set to be substantially square seen from the front, as shown in FIG. 3 and FIG. 4. Specifically, shape of the display unit 51a is set so that longitudinal size SL2 ranges from 0.95 to 1.2 when lateral size ST2 is 1. Then, more specifically, the longitudinal size SL2 is set to be approximately 1.1 when the lateral size ST2 is 1, for example. As for a specific size value, for example, the lateral size ST2 is set to be 56 mm and the longitudinal size SL2 is set to be 61 mm. The display contents of the display device body 1 will be described later.

The display device body 1 includes connection portions 55a and 55b for electrically connecting to the control unit 3.

The control unit 3 is structurally constituted by various kinds of circuits necessary for control on a substrate not shown in the drawing. As for functional constituent elements of the control unit 3, an image processing unit 21, a memory 23, a microcomputer 25, an operation unit 27, a clock circuit 29, a communication processing unit 57 and a power supply unit 59 are included.

Furthermore, the control unit 3 includes a plurality of connection portions 61a to 61d made up of connectors and the like. For example, the connection portion 61a and the connection portion 55a are connected, thereby electrically connecting the display panel unit 51, the image processing unit 21, and the power supply unit 59; and the connection portion 61b and the connection portion 55b are connected, thereby electrically connecting the backlight 53 and the power supply unit 59. Further, the in-vehicle camera 33 is electrically connected to the image processing unit 21 via the connection portion 61c. The connection portion 61d is connected to a local area network (referred to as LAN) or the like for connecting an other in-vehicle appliance such as the air conditioner 41 to the control unit 3.

The image processing unit 21 is to control a display image of the display device body 1 and operates by control of the microcomputer 25. As for a specific function of the image processing unit 21, a function as an interface of the display device body 1, various image processing functions to the display image of the display device body 1, and the like are included. As for the image processing function, for example, a rotation processing function (a processing function for rotating by 90 degrees so that a lateral direction becomes a longitudinal direction), a displaying function by cutting a part of the captured image and enlarging or the like, a displaying function by composing figure images representing an imaged region of the in-vehicle camera 33, and the like are included.

The memory 23 is used for image processing or the like by the image processing unit 21. The clock circuit 29 gives clock information showing time or the like to the microcomputer 25 or the like. A communication processing unit 57 performs information communication between an in-vehicle appliance such as the air conditioner 41 connected to the control unit 3 via LAN or the like and the microcomputer 25. The power supply unit 59 supplies power to the control unit 3, the display panel unit 51 and the backlight 53 of the display device body 1, and the like on the basis of electric power supplied from a battery not shown in the drawing.

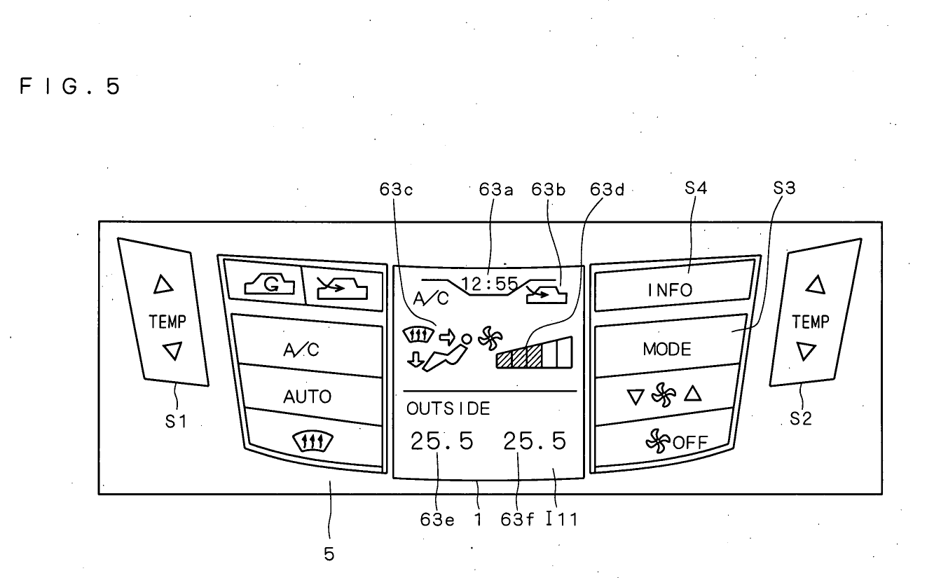

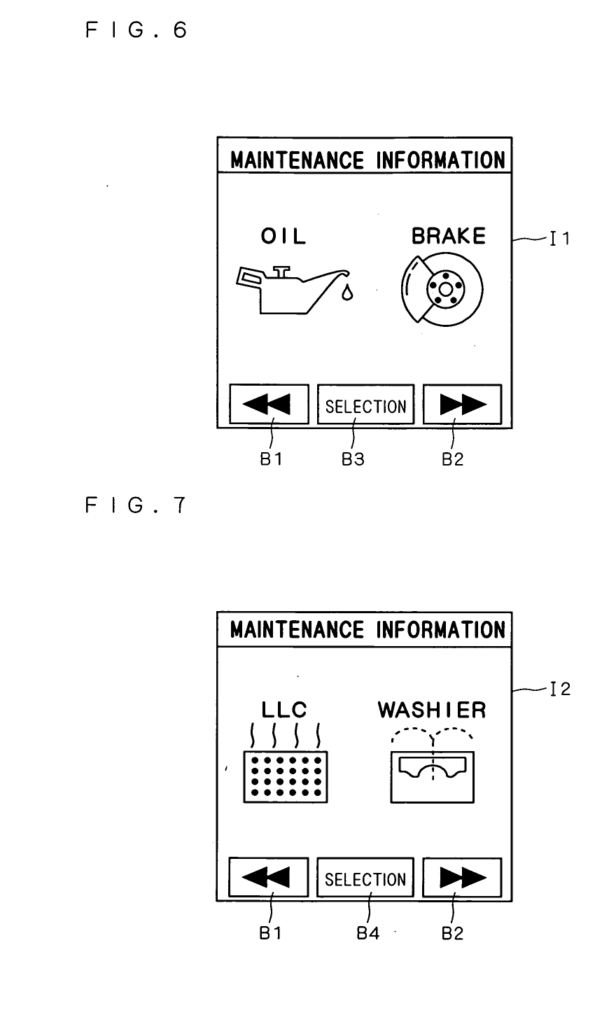

The operation unit 27 includes the aforementioned plurality of operation switches S for operating this in-vehicle display device and the air conditioner 41. To simply explain each of the operation switches S, as shown in FIG. 5, switches S1 and S2 are switches for changing temperature setting of each side of the air conditioner 41; operation switch S3 is a switch for switching a blowing out mode of the air conditioner 41 underfoot, entirely, or upward; and operation switch S4 is one for displaying information display screens I1 to I6 shown in FIG. 6 to FIG. 11 to be described later on the display device body 1.

Furthermore, one part (not shown in the drawing) of the operation switches S mounted on the operation unit 27 is installed on steering or in the vicinity thereof and used to switch an operation mode (to display operation information of the air conditioner 41, to display a captured image of the in-vehicle camera 33, or the like) of the in-vehicle display device.

The microcomputer 25 is to command control of the in-vehicle display device, the air conditioner 41, and the like and performs control of the air conditioner 41 together with performs control or the like of the display contents of the display device body 1 via the image processing unit 21 on the basis of various inputted signals. The microcomputer 25 switchably includes first and second modes as an operation mode for controlling the displaying contents of the display device body 1. Switching between the first and the second modes is performed on the basis of operation input via the operation switches S (not shown in the drawing) mounted on the steering.

In the first mode, information on operation of the air conditioner 41, information for vehicle control, and the clock information are switched to be displayed on the display device body 1 as shown in FIG. 5, for example. Selection of information to be displayed on the display device body 1 from these information is performed on the basis of operation input or the like via the operation unit 27. The information on the air conditioner operation and the information for the vehicle control are given to the microcomputer 25 via a connection portion 31e, for example. As the information for the vehicle control, information on the amount of remaining gasoline, information on fuel cost, information on travel distance, information on oil exchanging time, information on inspection time, information on diagnostic outcome given from a vehicle self-diagnosis device, and the like may be considerable.

Here, in a display image I11 of the display device body 1 shown in FIG. 5, an image 63a for displaying time, an image 63b for showing an opening/closing state of an air intake opening, an image 63c for showing an opening/closing state of each blowing out opening of air, an image 63d for showing the amount of air volume of the air conditioner, and images 63e and 63f for showing a setting temperature of the air conditioner for the driver seat and the front passenger seat are included.

In the displaying state shown in FIG. 5, for example, when the operation switch S4 is compressively operated, the display screen of the display device body 1 is switched from the state shown in FIG. 5 to the information display screens I1 to I6 shown in FIG. 6 to FIG. 11. In this embodiment, touch switches are provided as a part of the operation unit 27 on the display screen of the display device body 1 and switching of the information display images I1 to I6 is circularly performed by operating switch keys B1 and B2 on each of the screens I1 to I6 set by using the touch switches. For example, switching from the screen I1 to the screen I2 is performed when the switch key B2 of the screen I1 is operated; switching from the screen I2 to the screen 13 is performed when the switch key B2 of the screen I1 is operated; after that similarly, switching from the screen I6 to the screen I1 is performed when the switch key B2 of the screen I6 is operated. Furthermore, when the switch key B1 of each of the screens I1 to I6 is operated, the screens I1 to I6 are switched in the reverse order to this.

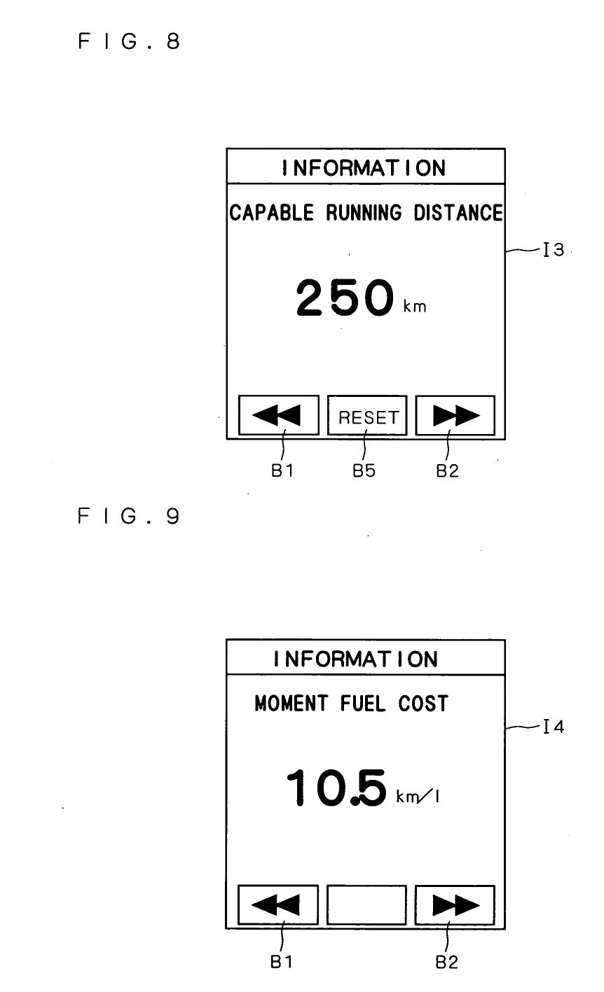

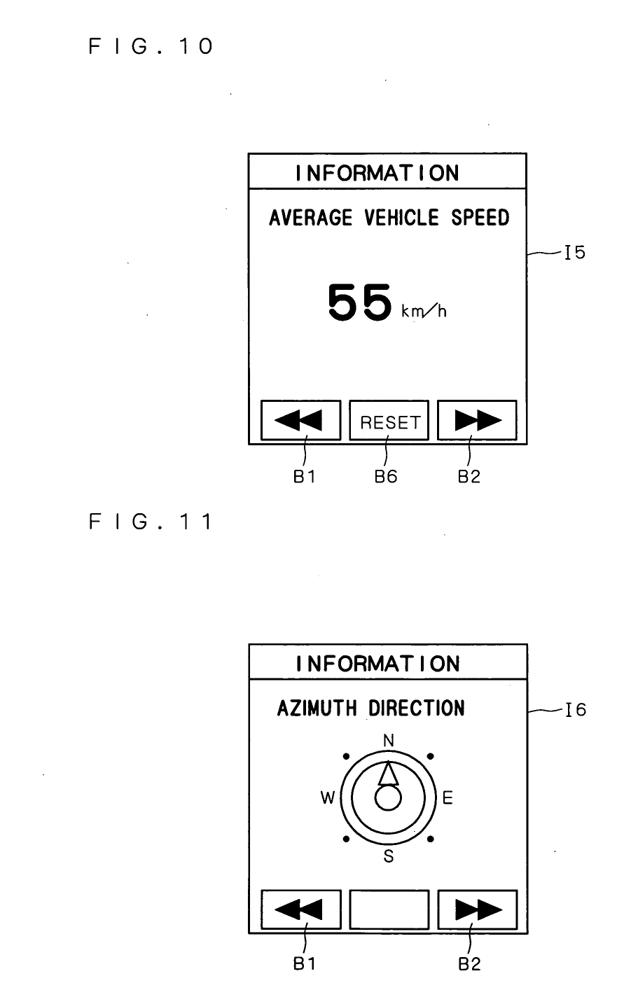

Here, the information display screen I1 of FIG. 6 is to display information on a state of oil and a brake; and the information on either oil or the brake to be displayed can be selected by operating a switch key B3. The information display screen I2 of FIG. 7 is to display information on a state of cooling water and washing liquid; and information on either the cooling water or washing liquid to be displayed can be selected by operating a switch key B4. The information display screen I3 of FIG. 8 is to display capable running distance; and the contents can be reset by operating a switch key B5. The information display screen I4 of FIG. 9 is to display moment fuel cost at the time. The information display screen I5 of FIG. 10 is to display average vehicle speed; and the contents can be reset by operating a switch key B6. The information display screen I6 of FIG. 11 is to display a proceeding direction (azimuth direction) of the vehicle at that point.

In the second mode, on the basis of an image signal inputted from the in-vehicle camera 33 via the connection portion 61c, the image Ia1 corresponding to the image signal is displayed on the display device body 1 (for example, refer to FIG. 3 and FIG. 4).

The in-vehicle camera 33 is an optional in-vehicle appliance and the vehicle surroundings monitor is constituted with the in-vehicle display device according to this embodiment by mounting this in-vehicle camera 33 on a vehicle. That is, the in-vehicle camera 33 is mounted on the vehicle so that a dead zone region which becomes a dead zone from the driver seat in the surroundings of the vehicle is captured. Then, the captured image of the in-vehicle camera 33 is displayed on the display device body 1 by the control of the control unit 3, whereby the driver or the like can easily monitor the surroundings of the vehicle by that display image. Therefore, in the case where the in-vehicle camera 33 is provided, the displaying state of the display device body 1 can be switchable between the state displaying operation information of the air conditioner 41 shown in FIG. 5 and the state or the like displaying a captured image Ia1 of the in-vehicle camera 33 shown in FIG. 3 or FIG. 4 by switching the operation mode of the in-vehicle display device by operating the operation switches S of the operation unit 27.

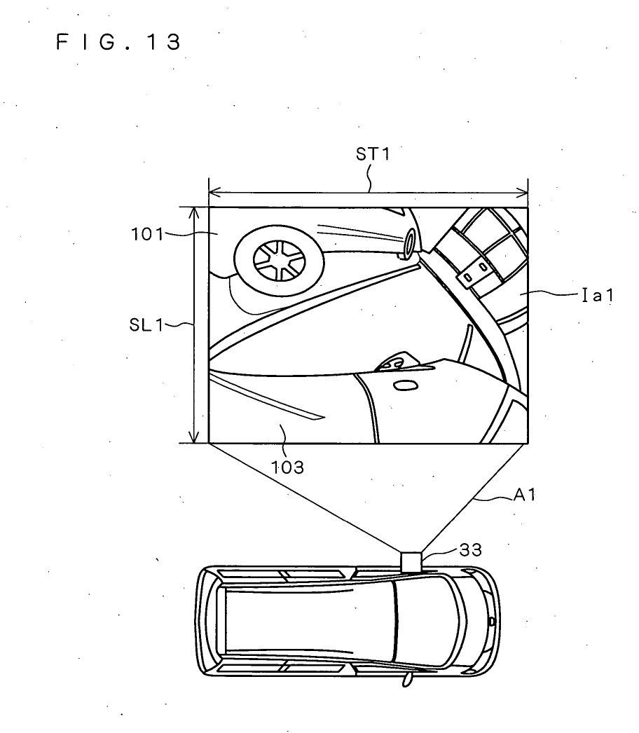

In this embodiment, as shown in the aforementioned FIG. 13, the in-vehicle camera 33 is mounted on the side portion (for example, the side mirror) of the front passenger seat side of the vehicle (for example, left side) so as to image the region opposed to the vehicle side in the surroundings of the vehicle (for example, a lateral region A1 of a front passenger seat side). The ratio between the lateral size ST1 and the longitudinal size SLI of the captured image Ia1 imaged by the in-vehicle camera 33 is set to 4 to 3.

Then, the captured image Ia1 imaged by the in-vehicle camera 33, as shown in FIG. 3, is rotated anticlockwise by 90 degrees within a plane parallel to the page space so that the longitudinal direction of the captured image Ia1 corresponds to a direction of motion of the vehicle and displayed on the display unit 51a in a state where the longitudinal size after rotation conforms to the longitudinal size SL2 of the display unit 51a. In this display aspect of FIG. 3, although size adjustment by isotropic enlargement processed lengthwise and breadthwise to the captured image Ia1 is performed, the display unit 51a is set to be substantially square and therefore an area of a use region 51b to the area of the display unit 51a is large (a usage rate of 75 percent) and a non-use region 51c generated on the right side or the like of the display unit 111a is also suppressed small, so that the display unit 51a is used with high use efficiency.

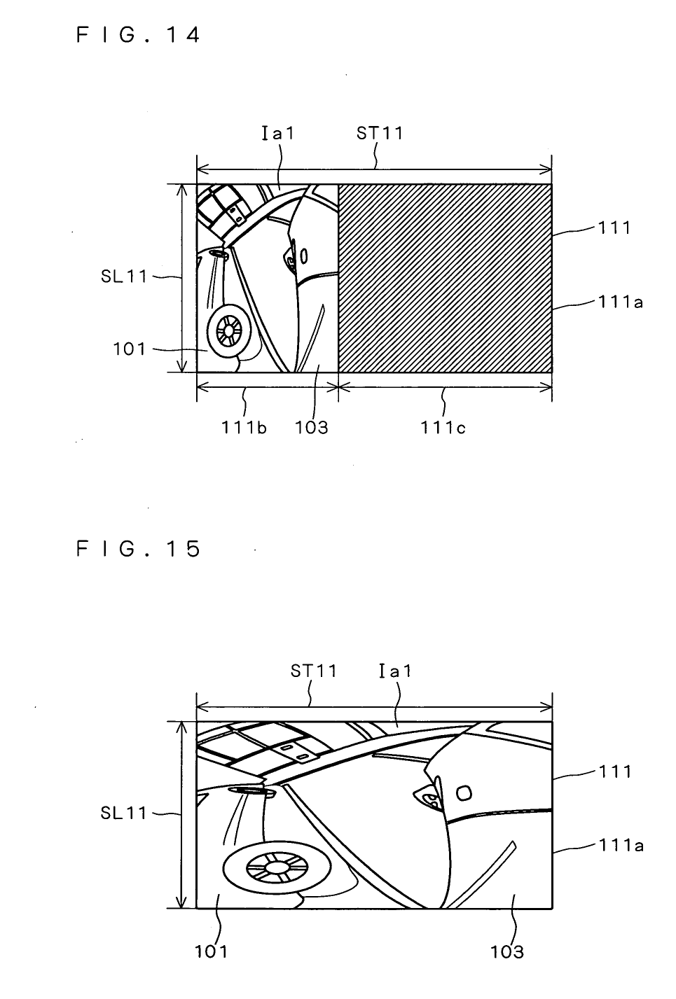

Furthermore, in an other display aspect of the captured image Ia1, an aspect shown in FIG. 4 may be considerable. In the display aspect of FIG. 4, the captured image Ia1 rotated by 90 degrees is displayed on the display unit 51a by performing anisotropic enlargement processed lengthwise and breadthwise (by enlarging the image Ia1 of FIG. 3 breadthwise) so that the lateral size and the longitudinal size after rotation conform to the lateral size ST2 and the lateral size SL2 of the display unit 51a. In addition, an enlargement factor (for example, approximately 1.3 times) when enlarging the image Ia1 breadthwise from the state of FIG. 3 to the state of FIG. 4 is considerably suppressed small compared to a conventional enlargement factor (for example, approximately 2.4 times) shown in the aforementioned FIG. 14 and FIG. 15 and strain of the image Ia1 is also suppressed.

As the display aspect of the captured image Ia1, any aspect of FIG. 3 or FIG. 4 may be adopted; display with either display aspect is performed may be selected by operation by a driver or the like; or display with either display aspect is performed may be set at initial setting.

As described above, according to this embodiment, the display panel unit 51 having the display unit 51a shaped in substantially square seen from the front is used. Therefore, the image Ia1 of the vehicle lateral region A1 in the surroundings of the vehicle, imaged by the in-vehicle camera 33 can be suppressed in strain due to anisotropic enlargement processed lengthwise and breadthwise; and the display unit 51a can be efficiently used to display in large size. In addition, the display panel unit 51 can be reduced in size.

Furthermore, in order to display operation information or the like of the air conditioner 41, the dot matrix display type display device is adopted in the in-vehicle display device (display device body 1) which is normally provided on a front panel 5 in the vehicle interior of a vehicle. Therefore, a vehicle in which a car navigation system is not mounted can thus also constitute a vehicle surroundings monitoring system using the display device and the captured image of the in-vehicle camera 33 can be displayed. As a result, the vehicle surroundings monitor can be introduced at low cost.

Further, the control unit 3 provided in the in-vehicle display device according to this embodiment switchably includes the first mode for displaying the operation information or the like of the air conditioner 41 on the display device body 1 and the second mode for displaying the captured image of the in-vehicle camera 33 on the display device body 1. Therefore, the vehicle surroundings monitor can be introduced by only adding the in-vehicle camera 33 or the like, without changing the configuration of the control unit 3.

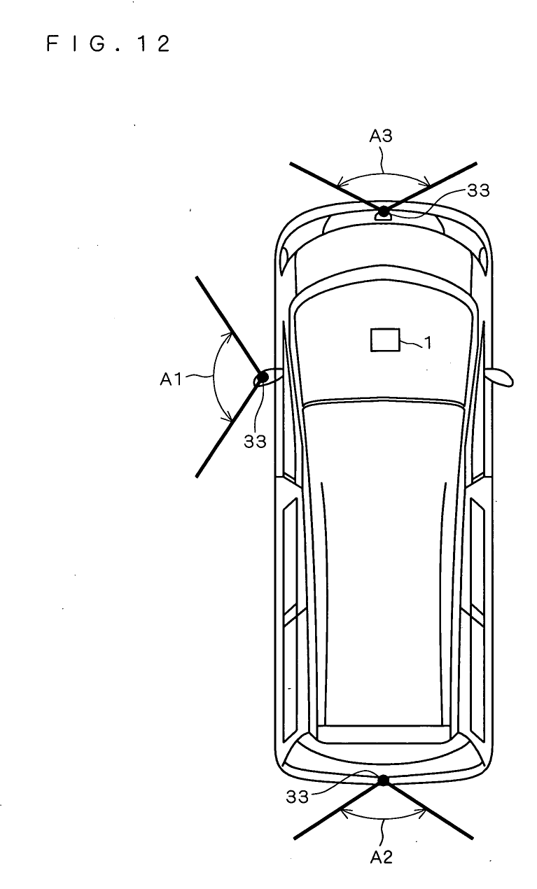

In addition, the following configuration may be considerable as a modified example of this embodiment. That is, as shown in FIG. 12, an other in-vehicle camera 33 is mounted on a back end portion of a vehicle in addition to the in-vehicle camera 33 provided on the vehicle side portion so that a region of the vehicle back end side (dead zone region) A2 is imaged by the in-vehicle camera 33. Further, an other in-vehicle camera 33 is mounted toward the front side of a vehicle (for example, on a front end portion of the vehicle) so that a dead zone region in the front side of the vehicle (for example, a region which cannot be watched from a driver seat because of a dark side of a front nose) A3 is imaged by the in-vehicle camera 33. Then, captured images captured by those three in-vehicle cameras 33 are displayed on the display device body 1. In addition, as a further modified example, of three in-vehicle cameras 33 shown in FIG. 12, only the in-vehicle camera 33 for imaging the backward side of the vehicle or the in-vehicle camera 33 for imaging the frontward side of the vehicle may be provided.

1. An in-vehicle display device mounted on a front panel in the vehicle interior of a vehicle, said in-vehicle display device comprising:
a dot matrix type display panel unit provided with a display unit which performs image display of the display panel unit and is set to be substantially square seen from the front.

2. The in-vehicle display device according to claim 1,
wherein said display unit of said display panel unit is set so that longitudinal size ranges from 0.95 to 1.2 when lateral size is 1.

3. The in-vehicle display device according to claim 2,
wherein said display unit of said display panel unit is set so that longitudinal size is set to be approximately 1.1 when lateral size is 1.

4. The in-vehicle display device according to claim 1, further comprising:
a control unit which switches at least any one piece of information of information on air conditioner operation, information for vehicle control, and clock information and displays on said display panel unit, and
said control unit switchably includes a first mode which switches at least any one piece of said information and displays on said display panel unit; and a second mode which displays, on the basis of an image signal which make input from an in-vehicle camera for imaging the surroundings of the vehicle, an image corresponding to the image signal on said display device body.

5. A vehicle surroundings monitor for displaying a captured image of the surroundings of a vehicle in the vehicle interior, said vehicle surroundings monitor comprising:
an in-vehicle camera which captures the surroundings of the vehicle; and
an in-vehicle display device as set forth in claim 1, which is mounted in the vehicle interior and displays an image captured by said in-vehicle camera.

6. The vehicle surroundings monitor according to claim 5,
wherein said in-vehicle camera captures a region opposed to the vehicle side in the surroundings of the vehicle.

7. The vehicle surroundings monitor according to claim 5,
wherein said in-vehicle camera captures a region of the vehicle backward in the surroundings of the vehicle.
